(19) United States
(12) Patent Application Publication
(10) Pub. No.: US 2019/0213580 A1
(43) Pub. Date: Jul. 11, 2019

(54) SYSTEM AND METHOD FOR PREPAID PURSE DRIVE PAYMENTS

(71) Applicant: Mastercard International Incorporated, Purchase, NY (US)

(72) Inventors: Andrew Buckley, Stamford, CT (US); Marvin Richard Johnson, Tampa, FL (US); Scott Hudson, Pearl River, NY (US); Thomas Robert Cronin, Danbury, CT (US)

(21) Appl. No.: 16/244,811

(22) Filed: Jan. 10, 2019

Related U.S. Application Data
(60) Provisional application No. 62/615,929, filed on Jan. 10, 2018.

(51) Int. Cl. G06Q 20/34; G06Q 20/40; G06Q 20/10

(52) U.S. Cl. CPC G06Q 20/3572; G06Q 20/10; G06Q 20/349; G06Q 20/405

(57) ABSTRACT

A prepaid spending card for the storage of funds, the prepaid spending card comprising a single primary account number. The prepaid spending card further comprises a first purse identified by a first pseudo DDA, the first purse authorized to received funds from any available funding source, and a second purse identified by a second pseudo DDA, the second purse authorized to send and receive funds only from restricted sources. The first pseudo DDA is used to route incoming funds to the first purse and the second pseudo DDA is used to route incoming funds to the second purse. Moreover, the first purse receives funds from any available funding source and the second purse receives from restricted funding sources.

### FIELD OF THE INVENTION

The present invention relates to the deployment and use of prepaid spending cards with multiple purses. Specific embodiments relate to the use of multiple purses on a single prepaid spending card, which may include various disparate restrictions on the multiple purses. Embodiments of the present invention also relate to systems and methods for controlling the funding and payment mechanisms available for use with purses on a prepaid spending card.

### BACKGROUND OF THE INVENTION

There exist situations where funds are to be disbursed to a banking customer, but different amounts or portions of such funds are intended for specific uses or payments. Similarly, there exist situations where a baking customer desires to receive funds from various or disparate sources, some of which are intended for specific uses or payments whereas other amounts are for unrestricted use. One such exemplary situation is the disbursement of student load funds to an individual student whereby a first portion of the funds received are restricted, e.g., earmarked for a specific use, and another portion of the funds received are earmarked for general use. At present, when restricted funds are allotted to an individual, such as a student receiving a federal student loan, the funds earmarked for the student are first disbursed to the restricted institution that is the intended recipient of the funds, e.g., a college or university. The institution takes the portion of the disbursement intended for the institution, such as tuition or other student fees, and then cuts a check or otherwise disburses the remaining funds to the student.

In an effort to develop more end user control over the disbursement of such funds, programs are underway that contemplate the disbursement of such restricted funds directly to students on pre-paid cards, rather than directly to the restricted institution. Payment control procedures, however, must be implemented to prevent unauthorized spending of these restricted funds. Furthermore, programmatic controls must be developed to allow for the use of restricted funds at a specific, restricted institution, alongside funds that are available for general use, as well as preventing co-mingling of funds.

It is with respect to these and other considerations that the disclosure made herein is presented.

### SUMMARY OF THE INVENTION

According to an aspect of the present invention, a prepaid spending card, as well as methods for funding and disbursing funds from such cards, are provided. It should be noted that although certain embodiments are presented in conjunction with prepaid spending cards, other cards and account types are equally applicable for use with the structures and functionality described herein. Furthermore, other credit access devices, such as mobile credit apps, are also contemplated as also falling within the scope of the claimed invention. For simplicity, all such structures shall be generically referred to herein as prepaid spending cards. According to other aspects of the present invention, system and methods are provided for funding disparate purses on a prepaid spending card, each purse having complete or partially disparate funding and payment mechanisms.

In accordance with one embodiment, the present invention is directed towards a prepaid spending card for the storage of funds, the prepaid spending card comprising a single primary account number associated with a first pseudo demand deposit account (DDA) and a second pseudo DDA. A first purse is identified by the first pseudo DDA, the first purse authorized to received funds from any available funding source and a second purse is identified by the second pseudo DDA, the second purse authorized to send and receive funds only to and from restricted sources.

A first purse identified by the first pseudo DDA receives funds from any available funding source and the second purse, identified by the second pseudo DDA receives funds from restricted funding sources. Each pseudo DDA is also used for routing incoming credits to each of the purses on the prepaid spending card, wherein the first pseudo DDA is used to route incoming funds to the first purse and the second pseudo DDA is used to route incoming funds to the second purse.

Disparate payment rails may also be utilized by each purse, wherein the first purse is associated with a first payment rail for settlement of transactions against the first purse and the second purse is associated with a second payment rail for settlement of transactions against the second purse. For example, the first payment rail may utilize ISO 8583 systems for transaction settlement whereas the second payment rail utilizes ISO 20022 systems for transaction settlement, an automated clearing house (ACH) transaction, etc. According to one embodiment, the second purse utilizes payment rails that provide for faster transaction settlement than the payment rails the first purse utilizes.

As used herein, the term “payment rails” refers to infrastructure associated with a payment network that may be used in the processing of payment transactions and the communication of transaction messages and other similar data between the payment network and other entities interconnected with the payment network when handling payment transactions. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include computing devices that are specially configured for the routing of transaction messages, which may be specially formatted data messages that are electronically transmitted via the payment rails. Payment rails in accordance with certain embodiments of the invention may comprise various combinations of the above-described hardware and software.

In addition to the foregoing, embodiments of the present invention are directed towards a method for utilizing a prepaid spending card for the storage of funds. The method according to one embodiment comprises generating a prepaid spending card identified by a single primary account number, the single primary account number associated with a first pseudo DDA and a second pseudo DDA. The method continues with authorizing a first purse identified by the first pseudo DDA to received funds from any available funding source and authorizing a second purse identified by the second pseudo DDA to send and receive funds only to and from restricted sources.

Embodiments of the methods in accordance with the present invention comprise the first purse receiving funds from any available funding source and the second purse receiving funds from restricted funding sources. Such controls may be implemented by routing incoming funds to the first purse through use of the first pseudo DDA and routing incoming funds to the second purse through use of the second pseudo DDA. Regarding debits, the method may comprise associating the first purse with a first payment rail for settlement of transactions against the first purse and associating the second purse with a second payment rail for settlement of transactions against the second purse. For example, associating with the first payment rail may comprise utilizing ISO 8583 systems for transaction settlement, whereas associating with the second payment rail comprises utilizing ISO 20022 systems for transaction settlement, an ACH transaction, etc. Other embodiments generally comprise the use of payment rails that provide for faster transaction settlement of transactions against the second purse than transactions against the first purse.

These and other aspects, features, and advantages can be appreciated from the following description of certain embodiments of the invention and the accompanying drawing figures and claims.

### BRIEF DESCRIPTION OF THE DRAWINGS

The invention is illustrated in the figures of the accompanying drawings, which are meant to be exemplary and not limiting and in which like references are intended to refer to like or corresponding parts, and in which:

FIG. 1 presents a flow diagram illustrating a technique for funding and debiting multiple purses associated with a prepaid spending card in accordance with one embodiment of the present invention;

FIG. 2 presents a block diagram illustrating the allocation of funds between various purses associated with a prepaid spending card in accordance with one embodiment of the present invention;

FIG. 3 presents a flow diagram illustrating a technique for allocating funds between various purses associated with a prepaid spending card in accordance with one embodiment of the present invention;

FIG. 4 presents a flow diagram illustrating a technique for selecting between various purses associated with a prepaid spending card to debit in response to a transaction in accordance with one embodiment of the present invention;

FIG. 5 presents a block diagram illustrating a technique for funding various purses on a prepaid spending card according to one embodiment of the present invention;

FIG. 6 presents a block diagram illustrating a technique for implementing various disbursement controls on different purses on a prepaid spending card according to one embodiment of the present invention; and

FIG. 7 presents a block diagram illustrating a technique for implementing various disbursement control on different purses on a prepaid spending card according to another embodiment of the present invention.

### DETAILED DESCRIPTION OF CERTAIN EMBODIMENTS OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

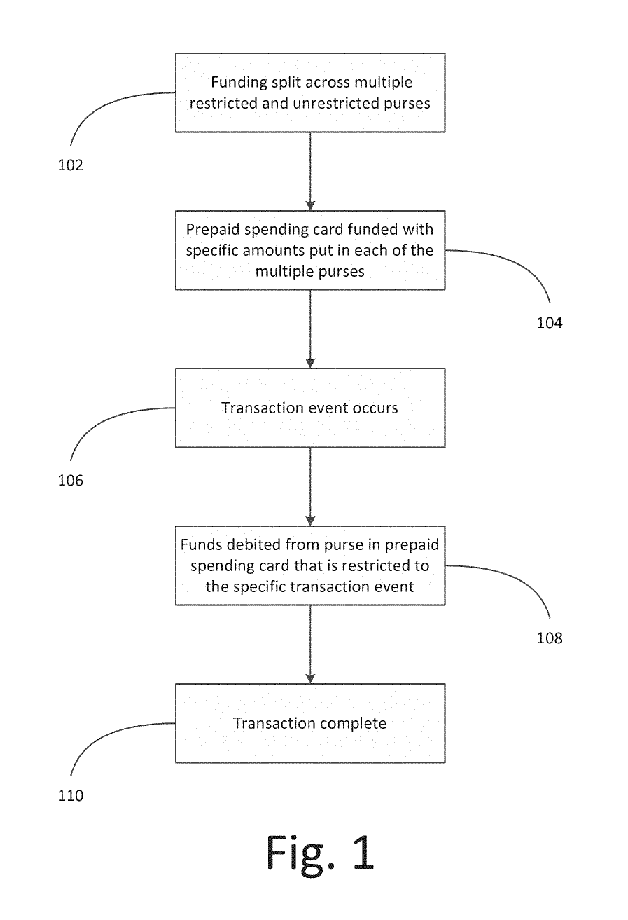

According to an aspect of the present invention, a prepaid spending card, as well as methods for funding and disbursing funds from the card, are provided. As discussed above, embodiments of the invention are directed towards a prepaid spending card that comprises multiple purses and in which one or more of the purses are restricted and one or more the purses are unrestricted. For example, where a college or university student receives a financial support package that consists of a tuition component and a living expenses component, a prepaid spending card in accordance with embodiments of the present invention may comprise a first, restricted purse to receive tuition funds and which is restricted to use with the college or university that the student is attending. A second, unrestricted purse may also be associated with the prepaid spending card that is operative to receive the living expenses component of the financial support package. FIG. 1 presents a flow diagram illustrating a technique for funding and debiting multiple purses associated with a prepaid spending card in accordance with one such embodiment of the present invention.

In accordance with the embodiment of the technique of FIG. 1, incoming funds are destined to be split across multiple restricted purses, step 102. A restricted purse in accordance with various embodiments of the present invention may have a pseudo-identifier that is valid only in association with a single primary account number (“PAN”), which may identify a prepaid spending card or other type of account with which the restricted purse is associated. The restricted purse also comprises or is associated with payment controls that restrict the institutions that may debit the funds from the restricted purse, as well as the specific transfer mechanisms available. The prepaid spending card may be associated with a plurality of restricted purses, each with distinct pseudo-identifiers and payment controls that circumscribe the manner, place and/or entity that may debit funds from a given restricted purse.

In addition to one or more restricted purses, the prepaid spending card may be associated with one or more unrestricted purses. As with the restricted purses, a given unrestricted purse in accordance with various embodiments of the present invention may have a pseudo-identifier that is valid only in association with a single PAN, which may identify a prepaid spending card or other type of account with which the unrestricted purse is identified. Distinct from the restricted purses, the unrestricted purse is not associated with the same manner of payment controls that limit those institutions that may debit the restricted purse. Indeed, the unrestricted purse is intended to be a general spend purse and may be presented for debit at any locations that accept the prepaid spending card.

The prepaid spending card is funded with specific amounts that are put in each of one or more restricted purses and unrestricted purse associated with the prepaid spending card, step 104. As such, various entities that are associated with each of the one or more restricted purses may be credited in accordance with disparate funding levels whereby such funds may only be debited in the manner or with the entity associated with restricted purse. Likewise, any unrestricted purses associated with the prepaid spending card may be credited; said funding need not take place synchronously with the funding of any restricted purses associated with the prepaid spending card.

Subsequent to the crediting the various restricted and unrestricted purses associated with a given prepaid spending card, the cardholder engages in a transaction event, step 106. In response to the transaction event, step 106, funds are debited from the purse associated with the prepaid spending card that is restricted to the specific transaction event, step 108. Following with one exemplary embodiment, the transaction event comprises a student visiting his or her bursar's office to effect a tuition payment. When the student uses the prepaid spending card to make the tuition payment, the institutions debits the restricted purse that contains funds restricted for its use.

Another transaction event 106 may indicate that the transaction is not associated with a restricted purse, but rather, is intended to debit an unrestricted purse associated with the prepaid spending card. Similar to debiting a restricted purse, step 108, a merchant debits the unrestricted purse in response to a transaction intended to be debited from a restricted purse. As is explained in greater detail herein, debiting funds from restricted and unrestricted purses associated with a prepaid spending card each may utilize different payment mechanisms and rails. The transaction completes upon successful debiting, step 110. It should be noted by those of skill in the art that the transaction also concludes if the debit event is unsuccessful, albeit without completion of the transaction.

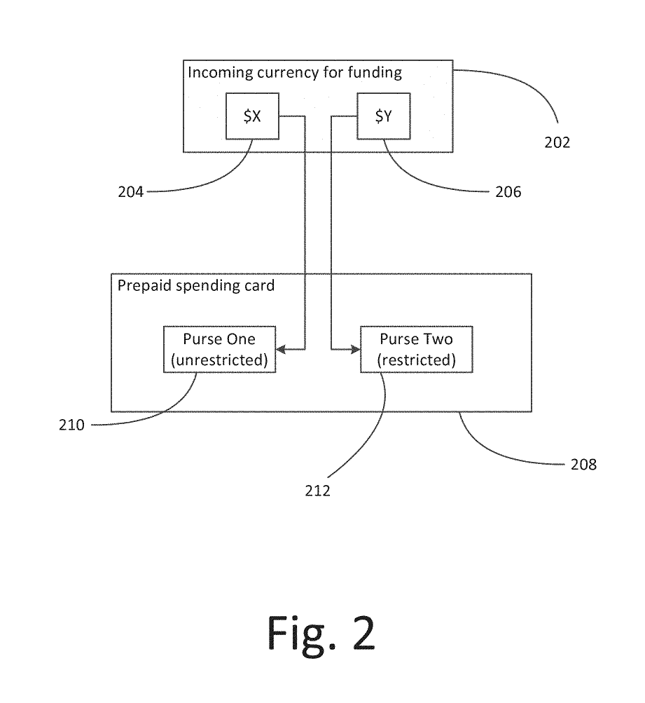

Funding the restricted and unrestricted purses associated with a prepaid spending card can come from a number of disparate sources, with each source funding the prepaid spending card on a per-purse basis. Alternatively, funds from a single source may be split among and used to credit restricted and unrestricted purses on a given prepaid spending card in accordance with various disparate amounts. FIG. 2 presents a block diagram illustrating the allocation of funds between various purses associated with a prepaid spending card in accordance with one embodiment of the present invention. The illustration of FIG. 2 is a logical one in which such structures may be reduced to software data structures to store value and payment control information associated with the prepaid spending card that is received from various sources, which may occur across one or more computer networks.

According to FIG. 2, incoming currency 202 is set to fund a prepaid spending card 208. The incoming currency is split into two distinct currency amounts, in the present embodiment two distinct dollar amounts: a first amount 204 and a second amount 206. Alternatively, or in conjunction with the foregoing, a single dollar amount may be set to credit the prepaid spending card 208. Upon clearing of sufficient funds, e.g., bank deposit or transfer by the cardholder of the prepaid spending card, deposit from a financial institution originating a student aid package for the cardholder, etc., the funds are used to credit one or more purses that are associated with the prepaid spending card. For example, a first set of funds 204 may be used to fund a first unrestricted purse 210 associated with the prepaid spending card 208. Similarly, a second set of funds 206 may be used to fund a first restricted purse associated with the prepaid spending card 208. Additional restricted and unrestricted purses may be associated with a given prepaid spending card 208, each of which may be funded at differing levels and implementing disparate payment controls and rails.

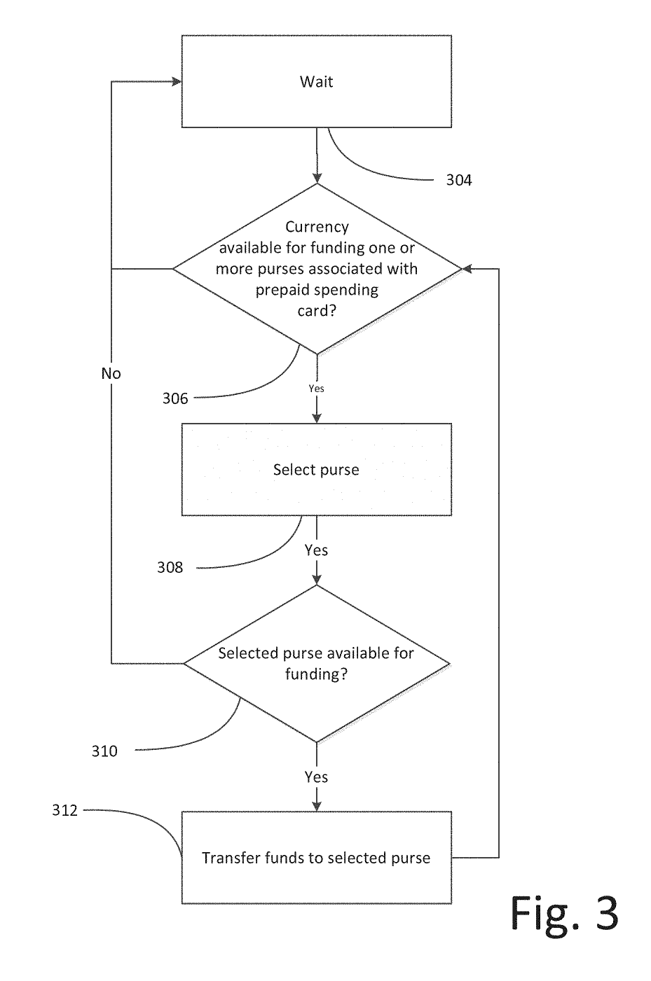

Building on the structures introduced in FIG. 2, FIG. 3 presents a flow diagram illustrating a technique for allocating funds between various purses associated with a prepaid spending card in accordance with one embodiment of the present invention. FIG. 3 nominally starts with the process in a wait state, step 304, awaiting the receipt of a signal indicating that currency is available for funding one or more purses associated with a prepaid spending card, step 306. For example, when a financial institution is issuing currency to fund a financial aid package for a student, the financial institution attempts to place the funds on the prepaid card of the student who is the intended recipient of the funds. Similarly, where the cardholder is deposing or transferring funds to the prepaid spending card, the system generates a signal indicating the availability of funds. Where the check at step 306 evaluates to false, program flow returns to step 304 with the system maintaining its wait state. A timer or similar construct may be deployed to periodically wake the process from its wait state to check for the presence of incoming credits, step 306.

In response to funds becoming available for crediting one or more purses associated with the prepaid spending card, step 306, the system selects a given purse associated with the prepaid card against which to credit the funds, step 308. The system performs a check to determine if the selected purse is available for funding, step 310. Where the purse is an unrestricted purse, such purse will generally be available for the receipt of incoming credits as there are generally neither restrictions on the amount of funds that the unrestricted purse may contain nor the manner in which the cardholder may debit such funds. A restricted purse may have certain limits or constraints on the amount of funds that the purse may hold at any given time, maximum incoming currency transfer limits, etc. Where such restrictions or requirements cannot be satisfied by the entity attempting to credit the purse, program flow returns to step 304 with the system maintaining its wait state. Error messages may be displayed or otherwise presented to indicate that the purse is not available and may optionally explain the reasons why the selected purse is not available.

In the event that the selected purse is available, the system proceeds to credit the available currency (step 306) into the selected purse associated with the prepaid spending card, step 312. Program flow returns to step 306 where the system performs a subsequent check to determine if additional currency is available for funding one or more purses associated with a prepaid spending card. Where the check at step 306 evaluates to false, program flow returns to step 304 with the system maintaining its wait state, otherwise a subsequent purse is selected and program flow proceeds in the above-described manner in accordance with steps 308, 310 and 312.

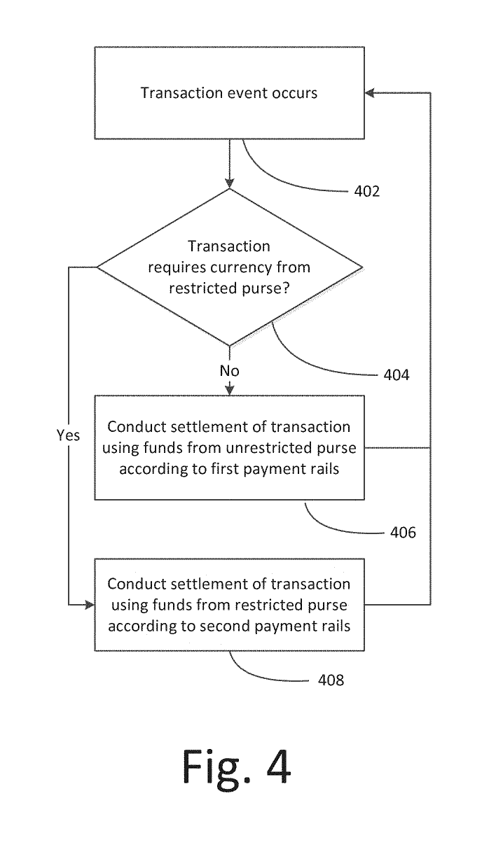

Once the one or more purses associated with a prepaid spending card are funded, such funds in both restricted and unrestricted purses are available to be spent by the cardholder. FIG. 4 presents a flow diagram illustrating a technique for selecting between various purses associated with a prepaid spending card to debit in response to a transaction in accordance with one embodiment of the present invention

The process of FIG. 4 begins with the occurrence of a transaction event, step 402, e.g., the cardholder has used the prepaid spending card in a manner that is resulting in the debiting of funds from one of the purses associated with the prepaid spending card. As such, the system performs a check to determine if the transaction requires currency from a restricted purse, step 404. Where the transaction involves a debit against the unrestricted purse, the system conducts settlement of the transaction by debiting funds from the unrestricted purse in accordance with the requirements set forth by a first payment rail, step 406. For example, where the system is attempting to settle a transaction by debiting a certain amount against the unrestricted purse, such transaction processing may be made in accordance with ISO 8583 authorization communication techniques, such techniques set forth at https://www.ibm.com/support/knowledgecenter/en/SSMKHH_9.0.0/com.ibm.etools.mft.doc/bd34064_.htm, et seq., and hereby incorporated herein by reference in their entirety. This type of transaction processing is well known and typically referred to as processing in accordance with the “four party” model, which consists of banks, cardholders, merchants, and networks. Accordingly, transactions involving debits against the unrestricted purse, which uses well know rails, allows for wide availability of use in purchasing all manner of goods and services. Processing returns to step 402 where the system awaits the next transaction for processing using the prepaid spending card.

Returning to step 404, the system performs a check to determine if a presently occurring transaction requires a debit against a restricted purse. Where the transaction involves a debit against the restricted purse, step 404, the system conducts settlement of the transaction using funds from the restricted purse in accordance with the requirements set forth by a second payment rail, step 408. For example, where the system is attempting to settle a transaction by debiting a certain amount against the restricted purse, such transaction processing may be made in accordance with ISO 20022, which is a universal financial industry messaging scheme, such techniques set forth at https://www.iso20022.org, et seq., and hereby incorporated herein by reference in their entirety. The second payment rail that the system utilizes to settle debits against the restricted purse may comprise use of an automated clearing house (“ACH”), which may comprise an electronic funds-transfer system run by the National Automated Clearing House Association (“NACHCA”). Accordingly, transactions involving debits against the restricted purse, which use direct payment rails, allow faster, specific and direct transfer of funds from the restricted purse to the receiving entity. Processing returns to step 402 where the system awaits the next transaction for processing against the prepaid spending card.

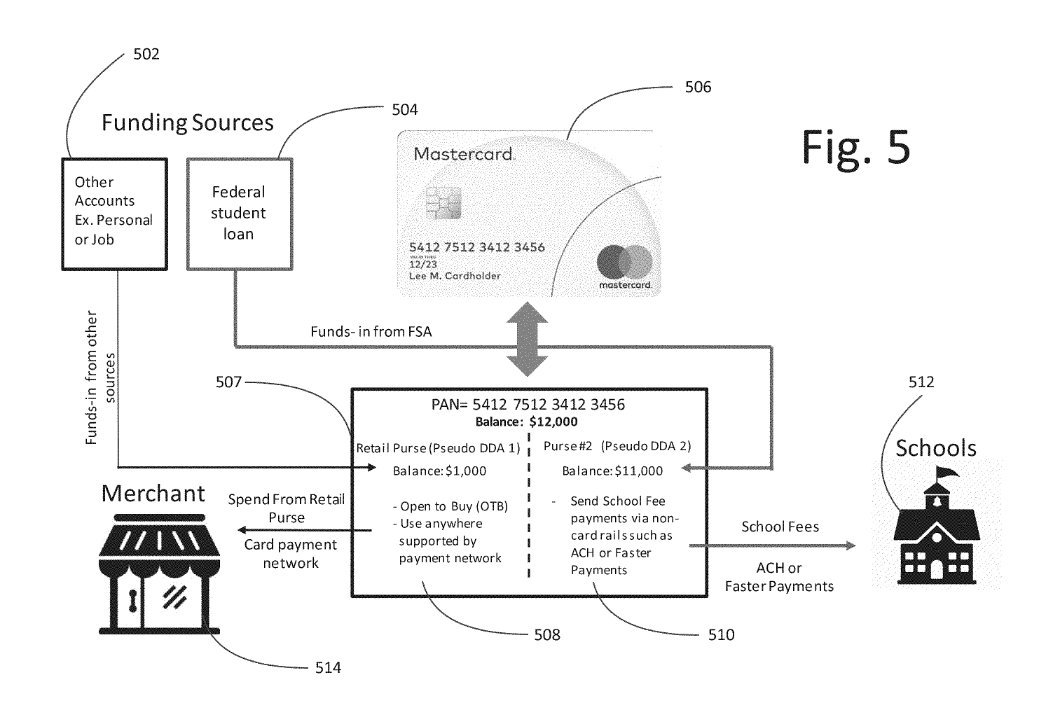

In one or more embodiments, prepaid spending cards are provided that are associated with, contain or have access to multiple purses, including both restricted and unrestricted purses. Several embodiments illustrating the various components involved in funding and debiting a prepaid spending card with both restricted and unrestricted purses, as well as the interaction between such components, is set forth in FIGS. 5 through 7.

According to the embodiment illustrated in FIG. 5, a prepaid spending card 506 associated with multiple purses is provided for the storage of funds that are received from various funding sources. A first purse 508, which is identified by a first pseudo DDA, is authorized to receive funds from any available funding source 502. For example, the first purse 508 could be funded with employee payroll funds that are send via direct deposit. In this scenario, the direct deposit would use the pseudo DDA identifying the first purse 508 to transfer funds to an account 507 associated with the prepaid spending card 506. When funds arrive at the institution controlling the prepaid spending card, such institution would utilize the account information PAN in the pseudo DDA to fund the first purse 508 on the account 507 tied to the card 506.

Beyond receiving funds from general sources 502, funds in the first purse 508 are available for general purchasing at all merchants 514 without restriction. In that regard, the prepaid spending card 506 can be used at a merchant like any other credit card or debit card and utilizes known payment rails for the settlement of transactions, e.g., when the prepaid spending card 506 is issued on the MASTERCARD® network, transactions are settled through the use of Mastercard payment rails with stand four-party model and associated interchange.

In addition to the first purse 508, the account 507 associated with or tied to the prepaid spending card 506 is associated with a second purse 510 identified by a second pseudo DDA. The second purse 510 is authorized to receive funds only from restricted sources 504. For example, the second purse could be funded with money received from a federal student load disbursement, which may arrive by any one of multiple mechanisms, including the direct deposit of funds into the second purse 510. In this scenario, the direct deposit would use the pseudo DDA identifying the second purse 510 to transfer funds to an account 507 associated with the prepaid spending card 506. When funds arrive at the institution controlling the prepaid spending card, such institution would utilize the account or PAN information in the pseudo DDA to fund the second purse 510 on the card 506. The illustration of a first and second purse, 508 and 510 respectively, are indented to be exemplary and not limiting; any number of purses and purse types, e.g., restricted and unrestricted, can be associated with the account 507.

Beyond receiving funds from restricted sources 504, funds in the second purse 510 are available for use with only restricted institutions, such as a school 512 that the cardholder attends. For example, where the funds are from a federal student loan, the user cannot spend these funds on general retail payments, but rather, is restricted in his or her spend locations to those specified by a program associated with the second purse 510, such as payment at select locations at the user's college or university 512. According to one embodiment, debits made to the second purse 510 do not occur through use of the standard card payment network, but rather, use of the second purse 510 is limited to selected payment rails and in accordance with selected payment terms, e.g., payment through the use of an ACH, fast ACH or same-day ACH, referred to herein as “Faster Payments”. Furthermore, payments made from the restricted purse 510 may come with different economics from the first purse (e.g., no interchange) and different payment terms (e.g., Net90). In accordance with other embodiments, use of the second purse 510 occurs through the use of the standard card payment network, which may be the same technique utilized in conjunction with the first purse.

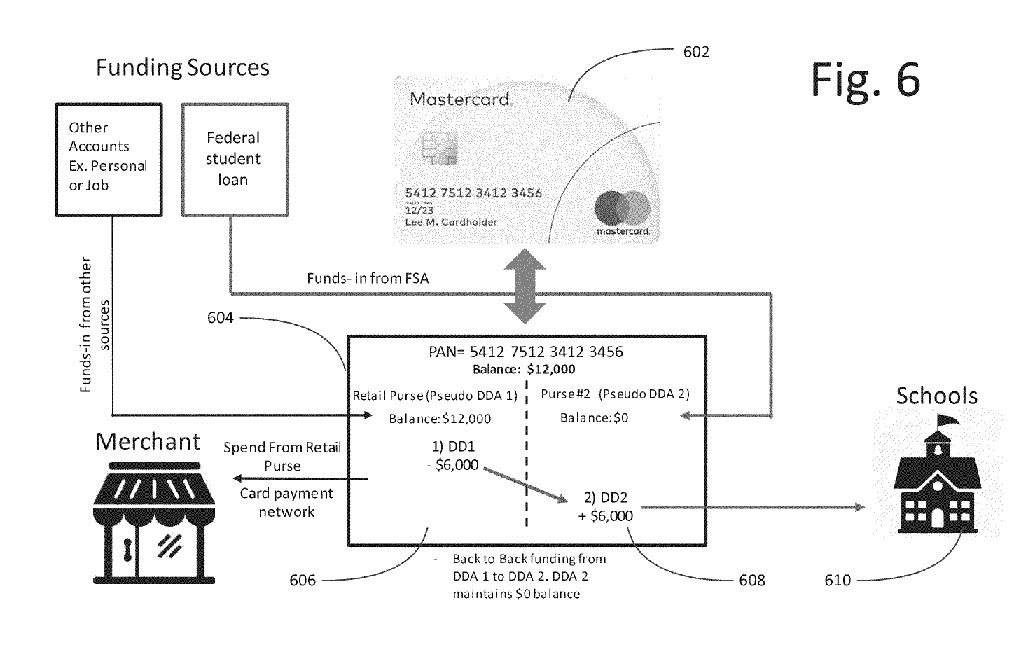

FIG. 6 illustrates a prepaid spending card that is provided for the storage of funds that are associated with multiple purses according to one embodiment of the present invention. Like FIG. 5, the prepaid spending card 602 of FIG. 6 comprises multiple purses 606 and 608 each identified by its own pseudo DDA to allow for the issuing institution to properly route funds to the account 604 associated with the card 602. More specifically, funds are routed the specific purse that the pseudo DDA identifies, e.g., a first general spend purse 606 or a second restricted spend purse 608.

In the embodiment that FIG. 6 illustrates, payments from the second, restricted purse 608 to the restricted payment institution 610 are done with back-to-back funding from the purse 606 associated with pseudo DDA1 to the purse 608 associated with pseudo DDA2. In this illustrative embodiment, the purse 608 associated by or identified with pseudo DDA2 would maintain a zero-dollar balance ($0) until the time of the payment transaction. Upon payment to the restricted payment source 610, the payment amount is debited (deducted) from the purse 606 associated with pseudo DDA1 and credited (added) to the purse 608 associated with pseudo DDA2. A subsequent transaction is then performed to deduct the funds from the purse 608 associated with pseudo DDA2 to the school or other restricted receiving entity 610.

The institution issuing the prepaid spending card 602 may implement flexible payment controls, which the institution may centrally define, allowing students, for example, to pay by academic term and not disburse all annual funds in a single transaction. Like payment controls, restricted reporting options are also available across embodiments that allow, for example, a purse to show only its available balance with back-to-back funding at the time the spend transaction executes.

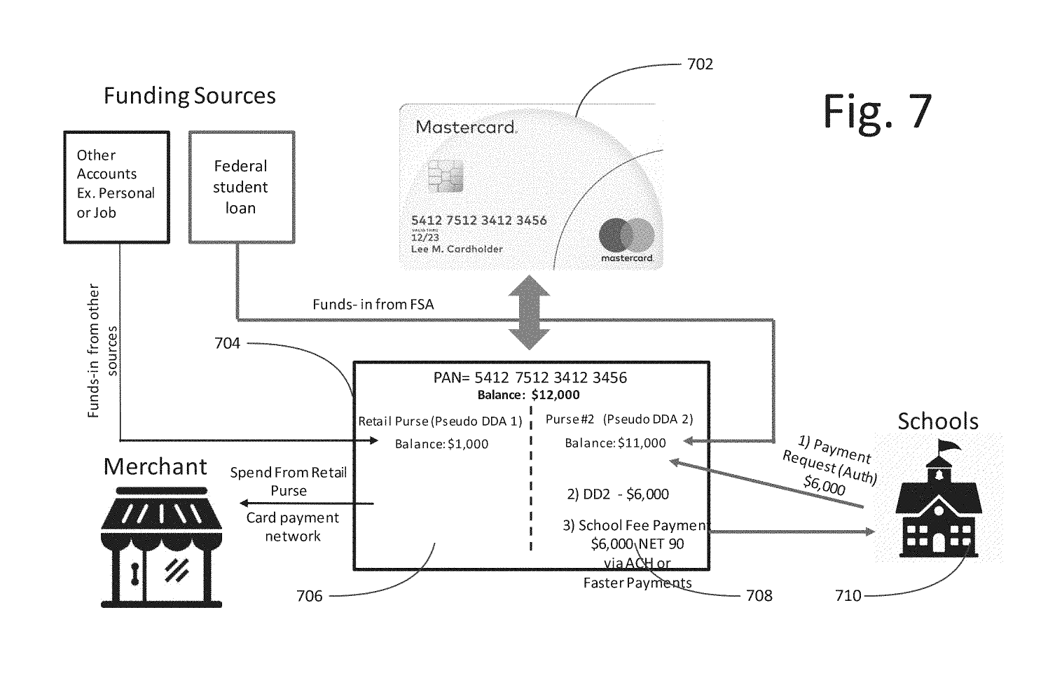

FIG. 7 illustrates another embodiment of a prepaid spending card that is provided for the storage of funds and associated with multiple purses. Like FIGS. 5 and 6, the prepaid spending card 702 of FIG. 7 comprises multiple purses that are each identified by their own pseudo DDA to allow for the issuing institution to properly route funds to the account 704 associated with the card. More specifically, funds are routed the specific purse that the pseudo DDA identifies, e.g., a first general spend purse 706 or a second restricted spend purse 708.

The illustrative embodiment of FIG. 7 provides options for hybrid card authorization to confirm that users (e.g., students) have funds to pay fees so they can start school, but then be paid payments in 90-day terms. In accordance with example of FIG. 7, assume that a school 710 makes payment authorization request, e.g., for $6,000.00, via a payment network to confirm that a student has the amount available in the second purse 708 that is identified by pseudo DDA2. Assume further that the student has $11,000 in his or her account, which would result in the payment authorization request placing a hold on the requested amount, e.g., $6,000. This is similar to a security deposit hold set on a credit card, which is well known to those of skill in the art. At a later date, e.g., Net30, Net60, etc., which may be set at the program level, payment is sent by ACH, Faster Payments, etc., although the use of a card payment network for settlement of the transaction is within the scope of the various embodiments of the invention. The school ultimately receives the payments a number of days subsequent to the original authorization, with payment settlement and clearance.

Illustrative embodiments and arrangements of the present systems and methods provide a system and a computer implemented method, computer system, and computer program product for inspecting smart structures. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, or one or more of the blocks can be repeated, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been described with reference to exemplary embodiments, it will be understood by those skilled in the art that various changes can be made, and equivalents can be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A prepaid spending card for the storage of funds, the prepaid spending card comprising:
A single primary account number associated with a first pseudo DDA and a second pseudo DDA;
A first purse identified by the first pseudo DDA, the first purse authorized to received funds from any available funding source; and
A second purse identified by the second pseudo DDA, the second purse authorized to send and receive funds only to and from restricted sources.

2. The prepaid spending card of claim 1 wherein the first purse receives funds from any available funding source and the second purse receives funds from restricted funding sources.

3. The prepaid spending card of claim 1 wherein the first pseudo DDA is used to route incoming funds to the first purse and the second pseudo DDA is used to route incoming funds to the second purse.

4. The prepaid spending card of claim 1 wherein the first purse is associated with a first payment rail for settlement of transactions against the first purse.

5. The prepaid spending card of claim 4 wherein the first payment rail utilizes ISO 8583 systems for transaction settlement.

6. The prepaid spending card of claim 1 wherein the second purse is associated with a second payment rail for settlement of transactions against the second purse.

7. The prepaid spending card of claim 6 wherein the second payment rail utilizes ISO 20022 systems for transaction settlement.

8. The prepaid spending card of claim 6 wherein the second payment rail utilizes an ACH for transaction settlement.

9. The prepaid spending card of claim 1 wherein the second purse utilizes a payment rail that provides for faster transaction settlement than the payment rail that the first purse utilizes.

10. A method for utilizing a prepaid spending card for the storage of funds, the method comprising:
Generating the prepaid spending card identified by a single primary account number, the single primary account number associated with a first pseudo DDA and a second pseudo DDA;
Authorizing a first purse identified by the first pseudo DDA to received funds from any available funding source; and
Authorizing a second purse identified by the second pseudo DDA to send and receive funds only to and from restricted sources.

11. The method of claim 10 comprising the first purse receiving funds from any available funding source and the second purse receiving funds from restricted funding sources.

12. The method of claim 10 comprising routing incoming funds to the first purse through use of the first pseudo DDA and routing incoming funds to the second purse through use of the second pseudo DDA.

13. The method of claim 1 comprising associating the first purse with a first payment rail for settlement of transactions against the first purse.

14. The method of claim 13 wherein associating with the first payment rail comprises utilizing ISO 8583 systems for transaction settlement.

15. The method of claim 1 comprising associating the second purse with a second payment rail for settlement of transactions against the second purse.

16. The prepaid spending card of claim 15 wherein associating with the second payment rail comprises utilizing ISO 20022 systems for transaction settlement.

17. The prepaid spending card of claim 15 wherein associating with the second payment rail comprises utilizing an ACH for transaction settlement.

18. The prepaid spending card of claim 1 comprising utilizing a payment rail that provides for faster transaction settlement of transactions against the second purse than transactions against the first purse.
